(19) United States
(12) Patent Application Publication
(10) Pub. No.: US 2019/0005149 A1
(43) Pub. Date: Jan. 3, 2019

(54) GRAPH DIFFUSION SIMILARITY MEASURE FOR STRUCTURED AND UNSTRUCTURED DATA SETS

(71) Applicant: Nokia Solutions and Networks Oy, Espoo (FI)

(72) Inventors: Chu WANG, Union, NJ (US); Iraj SANIEE, New Providence, NJ (US)

(21) Appl. No.: 15/640,927

(22) Filed: Jul. 3, 2017

(51) Int. Cl. G06F 17/30

(52) U.S. Cl. CPC G06F 17/30958

(57) ABSTRACT

A memory is configured to store a dataset and a processor is configured to map the dataset to a plurality of objects. The objects are represented by corresponding values of a plurality of non-negative elements. The processor is also configured to construct a bipartite graph including a plurality of first nodes associated with the plurality of objects and a plurality of second nodes associated with the plurality of non-negative elements. The first nodes are linked to the second nodes by edges having weights equal to values of the non-negative elements that represent the corresponding first node. The processor is further configured to determine similarity values that indicate degrees of similarity between the plurality of objects based on a diffusion of a fluid mass through the bipartite graph according to the weights of the edges.

### FIELD OF INVENTION

The present disclosure is directed towards computer processing systems, and in particular, to computer-implemented systems and methods for processing and computing similarity measures for textual and non-textual information stored in electronic format.

### BACKGROUND

Networking technologies have enabled access to a vast amount of online electronic information. With the proliferation of networked consumer devices such as smart-phones, tablets, etc., users are now able to search and access information at virtually anytime and from any location. Search engines enable users to search for information over a network such as the Internet. A user enters one or more keywords or search terms into a web page of a web browser that serves as an interface to a search engine. The search engine identifies resources that are deemed to match the keywords and displays the results in a webpage to the user. A user typically selects and enters topical keywords into the web-browser interface to the search engine. The search engine performs a query on one or more data repositories based on the keywords received from the user. Since such searches often result in thousands or millions of hits or matches, most search engines typically rank the results and a short list of the best results are displayed in a webpage to the user. The results webpage displayed to the user typically includes hyperlinks to the matching results in one or more webpages along with a brief textual description.

The ranking and pruning of the search results into a shorter list of most relevant results can be based on values of similarities, where the results that are most similar to the query keywords are ranked higher than relatively less similar results. There are several known similarity measures sued to compute similarity values, and different types of data typically requires applying different similarity measures that use different algorithms to compute similarity values based on the data. For example, structured data and unstructured data typically entail applying different similarity measures. Furthermore, different similarity measures are typically needed for different types of data, such as textual data and non-textual (e.g., binary) data. One example of a conventional similarity measure is an overlap measure, which is typically used to compute similarity values for pairs of data points in a categorical data set in which each data point is assigned to (or labeled with) a particular category. As another example, a cosine similarity measure and inner product similarity measure are typically applied to data mining and machine learning tasks to calculate similarity values for continuous data sets. Categorical data sets and continuous data sets are both examples of structured data sets.

However, conventional similarity measures that are used to calculate similarity values from structured data sets are not necessarily effective for unstructured data sets such as text, audio, image, video, and the like. As a result, unstructured data sets are sometimes computationally transformed into a vector representation before applying a similarity measure to the vector representation of the unstructured data set. Examples of computational transformations used to convert unstructured text into a vector include the “term frequency-inverse document frequency” representation, which captures frequency information but loses order information of the words in the text, and deep learning approaches that map words into a dense, low-dimensional (typically no more than a few hundred tuple) vector.

Utilizing different similarity measures to compute similarity values for different types of structured and unstructured data, including textual and non-textual data, imposes a significant burden on computational resources, and has a correspondingly significant impact on the computational cost and time.

### SUMMARY OF EMBODIMENTS

The following presents a summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In some embodiments, a method is provided for implementation in a computer that includes at least one processor configured to execute instructions representing the method. The method includes mapping a dataset to a plurality of objects, wherein the objects are represented by corresponding values of a plurality of non-negative elements. The method also includes constructing a bipartite graph including a plurality of first nodes associated with the plurality of objects and a plurality of second nodes associated with the plurality of non-negative elements. The first nodes are linked to the second nodes by edges having weights equal to values of the non-negative elements that represent the corresponding first node. The method further includes determining similarities between the plurality of objects based on a diffusion of a fluid mass through the bipartite graph according to the weights of the edges.

In some embodiments, mapping the dataset to the plurality of objects includes mapping at least one of a categorical dataset, continuous dataset, or an unstructured dataset to the plurality of objects.

In some embodiments, the weight associated with an edge indicates a fraction of a fluid mass that transitions between a first node and a second node connected by the edge during the diffusion.

In some embodiments, a first weight associated with an edge indicates a first fraction of a fluid mass that transitions from the first node to the second node and a second weight associated with the edge indicates a second fraction of the fluid mass that transitions from the second node to the first node. The first weight is different than the second weight and the first fraction is different than the second fraction.

In some embodiments, the method also includes normalizing the weights associated with the edges so that the sum of weights of edges associated with each first node is equal to a predetermined value.

In some embodiments, determining the similarities between the plurality of objects based on the fluid masses includes loading one of the first nodes with a portion of a fluid mass, diffusing the portion from the one of the first nodes to a subset of the second nodes with fractions determined by weights of the edges connecting the one of the first nodes to the subset of the second nodes, and diffusing the portion from the subset of the second nodes to a subset of the first nodes with fractions determined by weights of the edges connecting the subset of the second nodes to the subset of the first nodes to complete a round of the diffusion.

In some embodiments determining the similarities between the plurality of objects based on the fluid masses includes iteratively performing a predetermined number of rounds of the diffusion.

In some embodiments, determining the similarities between the plurality of objects based on the diffusion includes setting similarities between the one of the first nodes and the plurality of second nodes equal to fluid masses at the plurality of second nodes following the diffusion.

In some embodiments, higher fluid masses at the plurality of second nodes indicate higher degrees of similarity with the one of the first nodes.

In some embodiments, an apparatus is provided that includes a memory configured to store a dataset and a processor. The processor is configured to map the dataset to a plurality of objects. The objects are represented by corresponding values of a plurality of non-negative elements. The processor is also configured to construct a bipartite graph including a plurality of first nodes associated with the plurality of objects and a plurality of second nodes associated with the plurality of non-negative elements. The first nodes are linked to the second nodes by edges having weights equal to values of the non-negative elements that represent the corresponding first node. The processor is also configured to determine similarities between the plurality of objects based on a diffusion of a fluid mass through the bipartite graph according to the weights of the edges.

In some embodiments, the dataset includes at least one of a categorical dataset, continuous dataset, or an unstructured dataset to the plurality of objects.

In some embodiments, the weight associated with an edge indicates a fraction of a fluid mass that transitions between a first node and a second node connected by the edge during the diffusion.

In some embodiments, a first weight associated with an edge indicates a first fraction of a fluid mass that transitions from the first node to the second node and a second weight associated with the edge indicates a second fraction of the fluid mass that transitions from the second node to the first node. The first weight is different than the second weight, and wherein the first fraction is different than the second fraction.

In some embodiments, the processor is configured to normalize the weights associated with the edges so that the sum of weights of edges associated with each first node is equal to a predetermined value.

In some embodiments, the processor is configured to determine the similarities between the plurality of objects by loading one of the first nodes with a portion of a fluid mass, diffusing the portion from the one of the first nodes to a subset of the second nodes with fractions determined by weights of the edges connecting the one of the first nodes to the subset of the second nodes, and diffusing the portion from the subset of the second nodes to a subset of the first nodes with fractions determined by weights of the edges connecting the subset of the second nodes to the subset of the first nodes to complete a round of the diffusion.

In some embodiments, the processor is configured to iteratively performing a predetermined number of rounds of the diffusion.

In some embodiments, the processor is configured to set similarities between the one of the first nodes and the plurality of second nodes equal to fluid masses at the plurality of second nodes following the diffusion.

In some embodiments, higher fluid masses at the plurality of second nodes indicate higher degrees of similarity with the one of the first nodes.

In some embodiments, a non-transitory computer readable medium is provided that embodies a set of executable instructions. The set of executable instructions are to manipulate at least one processor to map a dataset to a plurality of objects. The objects are represented by corresponding values of a plurality of non-negative elements. The set of executable instructions is also to manipulate the processor to construct a bipartite graph including a plurality of first nodes associated with the plurality of objects and a plurality of second nodes associated with the plurality of non-negative elements. The first nodes are linked to the second nodes by edges having weights equal to values of the non-negative elements that represent the corresponding first node. The set of executable instructions is also to manipulate the processor to determine similarities between the plurality of objects based on a diffusion of a fluid mass through the bipartite graph according to the weights of the edges.

In some embodiments, the set of executable instructions is to manipulate the at least one processor to load one of the first nodes with a portion of a fluid mass, diffuse the portion from the one of the first nodes to a subset of the second nodes with fractions determined by weights of the edges connecting the one of the first nodes to the subset of the second nodes, and diffuse the portion from the subset of the second nodes to a subset of the first nodes with fractions determined by weights of the edges connecting the subset of the second nodes to the subset of the first nodes to complete a round of the mass distribution process.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates a processing system that is configured to compute similarity values using a graph diffusion similarity measure according to some embodiments.

FIG. 2 illustrates a bipartite graph at four steps of a mass distribution process used to determine similarity values using a graph diffusion similarity measure according to some embodiments.

FIG. 3 is a flow diagram of a method of utilizing a graph diffusion similarity measure to determine similarity values for object nodes derived from a dataset according to some embodiments.

FIG. 4 is a table that compares similarity values determined using different similarity measures, including graph diffusion similarity measures, to a selection of different datasets.

FIG. 5 shows plots of error curves for a term frequency-inverse document frequency (tf-idf) representation of an Internet Movie Database (IMDb) movie review dataset according to some embodiments.

FIG. 6 shows plots of error curves for a compact embedded representation of the IMDb movie review dataset according to some embodiments.

### DETAILED DESCRIPTION

Computer-implemented systems and methods are described herein for computing similarity values between various types of electronic data objects using a single or universal type of similarity measure, which is referred to herein as a graph diffusion similarity measure. The systems and methods disclosed herein are applicable for computationally searching and finding values of similarities between electronic information objects that are accessible in a computer-readable format and, in some embodiments, are particularly applicable in the context of ranking search results resulting from a web-based search conducted over a network such as the Internet. The systems and methods disclosed herein are also applicable to a number of other computing applications such as, data clustering or categorizing applications, social network applications, data mining applications, and recommendation applications to name but a few examples.

Implementation of the systems and methods disclosed herein realize a number of technical and functional improvements in a computing apparatus. First, the systems and methods enable an implementing computing apparatus to compute similarities in different types of electronic data objects such as structured data objects and unstructured data objects using a single type of similarity measure. A computing apparatus in accordance with embodiments disclosed herein can compute similarities using a single similarity measure for various combinations of data objects such as textual data objects (documents, web-pages, email, messages, etc.) and non-textual data objects (e.g., binary data objects, audio data objects, video data objects, image data objects, sensor data objects, etc.). This is technically advantageous compared to conventional approaches, which typically entail having to compute similarity values using different similarity measures (e.g., by applying different algorithms to compute the similarity values) for respectively representing similarities between different types of data including textual data, non-textual data, structured data, and non-structured data.

Second, the systems and methods disclosed herein can enable a computing apparatus to compute similarity values using the disclosed similarity measure faster. It has been found that three or four rounds of iterations provide similarity values that may be sufficient for many applications, compared to conventional approaches, which, in addition to using different similarity measures for different data types, also typically require having to complete a greater number of iterations to compute similarity values within a comparable threshold of confidence.

Third, a computing apparatus implemented in accordance with the systems and methods disclosed herein typically requires fewer physical computational resources such as processor time, memory, etc. in view of the other advantages described above.

In various embodiments, systems and methods are provided herein for computing a type of similarity measure, referred to herein as the graph diffusion similarity measure, to compute similarity values that represent similarities between different data objects in a given data set. As will be apparent from the following description, the systems and methods disclosed herein can be applied to a wide variety of data sets such as categorical datasets, continuous datasets, and vector representations of unstructured data sets including text and non-textual data sets.

In some embodiments, a graph diffusion similarity measure is used to compute similarity values by mapping a data set n electronic data objects (e.g., the n data points in the dataset) where each of the objects is represented by a computed vector of m non-negative elements.

For example, an electronic dataset extracted from a movie review database can be mapped to n different reviews and each review is represented by an m-dimensional vector of features (m non-negative elements) that are determined based on the word content of the review. A bipartite graph is constructed that includes edges that link object nodes representing the n objects with feature nodes that represent the m non-negative elements. The edges are assigned weights that are equal to values of the non-negative elements in the feature vector for the corresponding object. The weights are used to indicate fractions of a fluid mass located at an object node that transition to the feature node via the edge, e.g., by diffusing during a mass distribution process. In some embodiments, the weight depends on the direction, e.g., the weight of an edge is different depending on whether the edge points from an object nodes to a feature node or from a feature node to an object node. A graph diffusion similarity measure determines similarity values for pairs of the object nodes by diffusing a fluid mass from the object nodes to the feature nodes and back (one round) for a predetermined number of rounds. For example, a mass of fluid that begins a mass distribution process at a first object node and ends the mass distribution process at a second object node is a similarity value that represents a degree of similarity between the first object node and the second object node. Higher similarity values (e.g., higher masses) indicate higher degrees of similarity between the destination object node and the originating object node. Each round can also be referred to as an iteration.

As used herein, the term object refers to an electronic entity in which information (either textual or non-textual) is stored in a computer-readable format. Some examples of electronic objects (also sometimes referred to as objects) include documents, publications, articles, web-pages, images, video, audio, databases, tables, directories, files, user data, or any other types of computer-readable data structures that include information stored in an electronic format. The type of information and the source of the information of the electronic objects may vary. In some embodiments, the source of the information is a data repository, such as one or more pre-configured databases of electronic publications, articles, webpages, images, audio, multi-media files etc. In some embodiments, the source of the information is more dynamic. In one embodiment, the source of information for the electronic objects is a set of query results that are obtained from a search using a conventional search engine. For example, a user may perform a conventional search using keywords in a conventional search engine such Google's or Microsoft's search engines. The set of data resulting from a search conducted via a conventional search engine may be the initial source of information that is stored in the electronic objects (e.g., as web-pages) that is processed further as described herein below. In another embodiment, the source of the information of the electronic objects is sensor data that is received from a number of different types of electronic sensors. The output of the sensors may be environmental data or other data such as temperature, pressure, location, alarm, etc., and may also be multimedia data such as audio or video data. The data from the sensors may be received and stored in a data repository as electronic objects and processed in accordance with the aspects described herein. In yet another embodiment the source of the data of the electronic objects described herein is user data. Some examples of such user data include a user's profile, contact data, calendar data, chat message data, email data, browsing data, social network data, or other types of data (e.g., user files) that are stored on a user's device to which access is allowed by a user for further processing as described below.

The terms “feature” or “non-negative element” as used in the present disclosure refer to particular information that is either determined to be part of information stored in an electronic object or is derived from information included in the object. The determined features or non-negative elements may be textual or non-textual. One example of determining textual features includes determining the text or words that are found an electronic document, publication, webpage etc. Another example of determining textual features includes determining text or words from metadata associated with an electronic object. In general, any textual information included in an electronic object may be a determined feature in accordance with the aspects described herein. Textual features may also be derived from non-textual information in an electronic object. For example, where an electronic object is an image (or a video) determining textual features from the image or video may include processing and recognizing non-textual content of the image or video. For example, a picture of a dog may be processed using image processing or machine learning techniques and textual features such as “dog”, its breed, its size, its color, etc. may be derived and identified from the picture. Similarly, non-textual audio data may be analyzed using audio, speech-to-text, or machine learning techniques and recognized words or other textual information derived from the audio may be determined as a feature of the image or video in accordance with the disclosure. Similarly, non-textual sensor data output by one or more sensors may be analyzed and characterized by one or more textual features such as “door open”, “fire”, “emergency”, temperature or pressure value, etc.

The determined features of an electronic object may also be non-textual. For example, returning to the example of an image or video, the features that are determined from the image or video may be a set of pixels in the image or the video that are recognized using object recognition, pattern recognition, or machine learning techniques. Alternatively, or in addition, the determined non-textual features may be a set of object or pattern recognition vectors or matrices that are determined based on the contents of the image or video. Non-textual features determined by analyzing an audio object may include a portion of musical or vocal tracks recognized within the audio using audio processing or machine learning techniques. Non-textual features determined from analyzing sensor output data may be all or part of sensor data associated with one or more recognized events captured by the sensors during one or more period of times.

In some embodiments, a user submits a query or requests a search, (via, by way of example only, a web-page in a browser), for information in a data set that is similar to a set of keywords or topics of interest to the user. In some embodiments, the query submitted by the user may include keywords that indicate one or more objects or features in the data set that are of particular interest to the user, and request identification of other objects or features in the data set that are most similar to the object or feature identified by the user. In some embodiments, a user may provide or identify a data set of interest and request categorization of the data set based on similarity of objects and/or features found in the dataset.

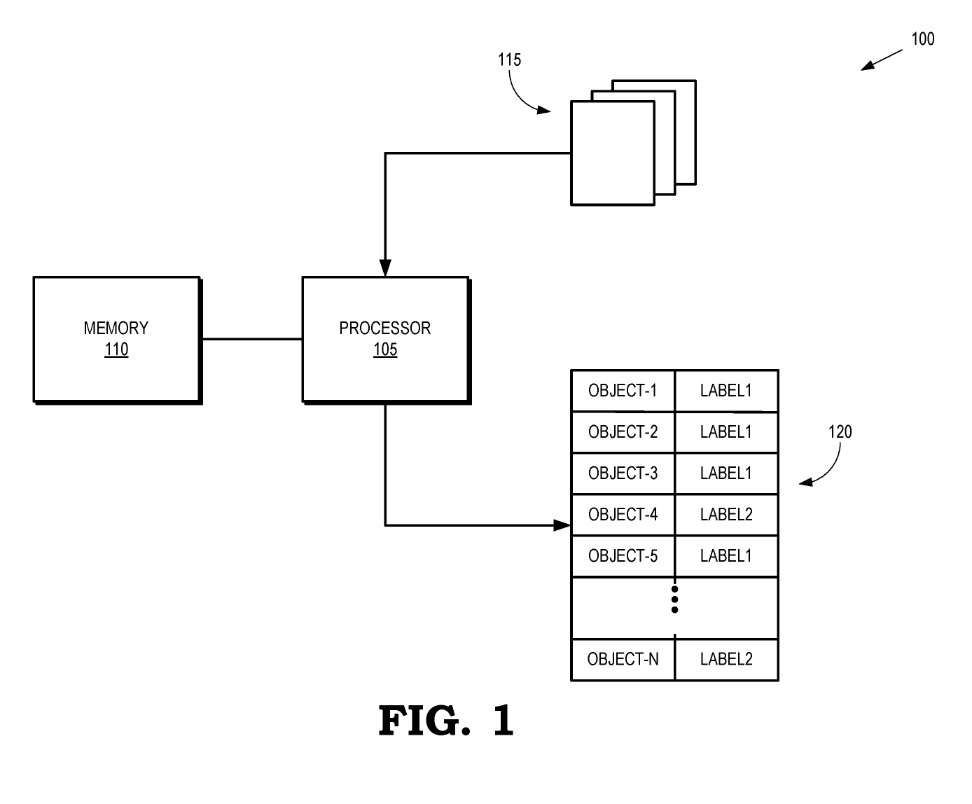

FIG. 1 illustrates a processing system 100 that is configured to compute similarity values using a graph diffusion similarity measure according to some embodiments. The processing system 100 includes a processor 105 and a memory 110 for storing data or instructions. The processor 105 is configured to execute instructions stored in the memory 110 and perform operations on the data stored in the memory 110. The processor 105 may also store the results of the executed instructions in the memory 110. For example, the memory 110 can store instructions that are executed by the processor 105 to compute similarity values by applying the graph diffusion similarity measure to the information in the dataset. The processor 105 can then store the similarity values in the memory 110. The memory 110 is implemented as a non-transitory computer readable medium such as a random access memory (RAM), a non-volatile memory, a flash memory, and the like.

The processor 105 receives a dataset 115, which can be a categorical dataset, continuous dataset, an unstructured dataset, or other dataset. Some embodiments of the processor 105 store information in the dataset 115 in the memory 110 so that the processor 105 can subsequently access the dataset 115 from the memory 110. The processor 105 can also access the dataset 115 from an external memory (not shown in FIG. 1). The processor 105 is configured to map the dataset 115 to a plurality of objects. Each of the objects corresponds to a data point in the dataset 115 and is represented by non-negative values of elements of a vector of features. The processor 105 is also configured to construct a bipartite graph (not shown in FIG. 1) including a set of object nodes associated with the mapped objects and a set of feature nodes associated with the non-negative elements of the vector of features. The object nodes in the bipartite graph are linked to the feature nodes by edges having weights equal to values of the non-negative elements that represent the corresponding object node. The processor 105 is further configured to determine similarity values that represent similarities between the mapped objects based on a mass distribution on the bipartite graph according to the weights of the edges. For example, the weights indicate fractions of a fluid mass that transition from an object node to a feature node (or vice versa) during the mass distribution process. The values of the similarities are used to identify labels for the objects and the corresponding data points in the dataset 115.

Some embodiments of the processor 105 produce a labeled dataset 120 using the similarity values that are computed by applying the graph diffusion similarity measure. The labeled dataset 120 includes information indicative of the objects, which are represented in FIG. 1 as “OBJECT-1,” “OBJECT-2,” to “OBJECT-N.” The objects are associated with (or labeled with) labels that indicate subsets of the objects (or data points) identified using the graph diffusion similarity measures. For example, objects that are determined to be similar to each other, as indicated by relatively high similarity values, can be labeled with the same label. The labeled dataset 120 includes objects that are labeled with one of two labels “LABEL1” and “LABEL2” that indicate two mutually exclusive subsets of the objects or data points. The objects in the labeled dataset 120 are organized based on their similarities to the first or second subset. For example, objects that are similar to the first subset (LABEL1) are at the top and objects that are similar to the second subset (LABEL2) are at the bottom of the labeled dataset 120. In the illustrated embodiment, OBJECT4 is above OBJECT5, but OBJECT4 is labeled with LABEL2 while OBJECT5 is labeled with LABEL1. Thus, either OBJECT4 or OBJECT5 may be mislabeled, which indicates an error in the similarity values for one or both of the objects, as discussed below.

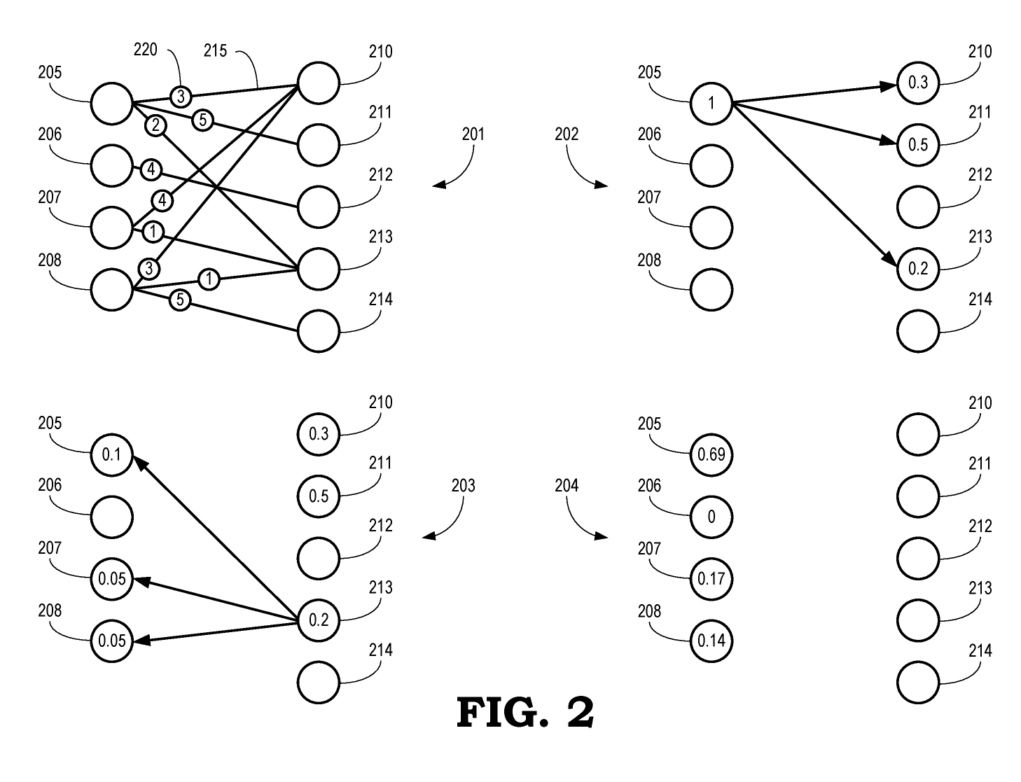

FIG. 2 illustrates an example of a bipartite graph illustrating four steps 201, 202, 203, 204 of a computed mass distribution used to determine similarity values using a graph diffusion similarity measure according to some embodiments. The bipartite graph includes a set of n object nodes 205, 206, 207, 208 (collectively referred to herein as “the object nodes 205-208”) and a set of m feature nodes 210, 211, 212, 213, 214 (collectively referred to herein as “the feature nodes 210-214”). In the illustrated embodiment, n=4 to indicate that there are four objects represented by the object nodes 205-208 and m−5 to indicate that there are five dimensions, or five non-negative elements, in the feature vector represented by the feature nodes 210-214. Each of the object nodes 205-208 are associated with different values of the m features and these values are used to provide the weights of edges between the object nodes 205-208 and the feature nodes 210-214. Continuous datasets, binary datasets, and vector representations of unstructured data can be mapped directly to the bipartite graph. Categorical datasets can be mapped to the bipartite graph, e.g., by replacing a categorical feature having l different categories by an l bits, one-hot binary feature vector.

At the first step 201, the object nodes 205-208 are linked to the feature nodes 210-214 by corresponding edges 215 (only one indicated by a reference numeral in the interest of clarity). The edges 215 are associated with weights 220 (only one indicated by a reference numeral in the interest of clarity) that indicate fractions of a fluid mass at the object nodes 205-208 that transition to the feature nodes 210-214 (or vice versa) during the mass distribution process. For example, the weight 220 for the edge 215 that connects the object node 205 to the feature node 210 has a value of 3. In the illustrated embodiment, the weights 220 are symmetric so that the fraction of the fluid mass that transitions from the object node 205 to the feature node 210 is the same as the fraction of the fluid mass that transitions from the feature node 210 to the object node 205 via the edge 220 during the mass distribution process. However, in some embodiments, the weights 220 are asymmetric, or directional, so that the fraction of the fluid mass that transitions from the object node 205 to the feature node 210 is different than the fraction of the fluid mass that transitions from the feature node 210 to the object node 205 during the distribution process. In the illustrated embodiment, the weights are not normalized so that the sum of the weights originating at the object nodes 205-208 is not normalized to a predetermined value, such as one. For example, the sum of the weights originating from the object node 205 is ten and the sum of the weights originating from the object node 207 is five. However, in some embodiments, the weights can be normalized so that the sum of the weights originating from each of the object nodes 205-208 is equal to a predetermined value, such as one.

At the second step 202, the object node 205 is loaded with a fluid of total mass of one, although any predetermined value can be used to represent the mass of the fluid. The object node 205 is linked to the feature nodes 210, 211, 213 by corresponding edges. The fluid mass is then diffused from the object node 205 to the feature nodes 210, 211, 213 in a distribution process. During the first portion of a first iteration of diffusion, portions of the mass in the object node 205 transfer to the feature nodes 210, 211, 213 at a proportion indicated by the weight of the corresponding edge. The masses at the feature nodes 210, 211, 213 are therefore proportional to the weights of the corresponding edges, e.g., the mass at the feature node 210 is 0.3, the mass at the feature node 211 is 0.5, and the mass at the feature node 213 is 0.2. The total mass is conserved during the diffusion process, e.g., the total mass at the end of step 202 remains equal to one even though the total mass is distributed among the feature nodes 210, 211, 213.

At the third step 203, which corresponds to a second portion of the first iteration, the fluid masses at the feature nodes 210-214 diffuse back towards the object nodes 205-208 along corresponding edges with proportions indicated by the weights of the edges. For example, the feature node 213 is connected by edges to the object node 205, the object node 207, and the object node 208. The mass at the feature node 213 is therefore distributed to the object nodes 205, 207, 208 with proportions that are given by the weights of the corresponding edges. The mass of the fluid that diffuses from the feature node 213 to the object node 205 is therefore 0.1, the mass of the fluid that diffuses from the feature node 213 to the object node 207 is 0.05, and the mass of the fluid that diffuses from the feature node 213 to the object node 208 is 0.05. Diffusion of mass from the object nodes 205-208 to the feature nodes 210-214 and back to the object nodes 205-208 completes the first iteration, which is also referred to as a round of the distribution process.

At the fourth step 204, the predetermined number of iterations or rounds of computation of the mass distribution have been completed. The mass of fluid that originated at the object node 205 and returned to the object node 205 is equal to 0.69, which is expected because object nodes are very similar to themselves. The mass of fluid that originated at the object node 205 and arrived at the object node 206 is zero because there are no edges that connect the object node 205 to the object node 206 via any of the feature nodes 210-214, which indicates that the object nodes 205, 206 are dissimilar. The mass of fluid that originated at the object node 205 and arrived at the object node 207 is equal to 0.17 and the mass of fluid that originated at the object node 205 and arrived at the object node 208 is equal to 0.14, which indicates that the object node 205 is relatively more similar to the object node 207 that it is to the object node 208.

The graph after each of the computed steps 201-204 can be referred to as an induced subgraph of the object nodes. The induced subgraph after one iteration or round (2 steps) gives rise to an object-object graph that can be denoted by Γ. In the language of Markov chain theory, the 2m-step distribution on B is the first m rounds of iterations in the computation of the stationary distribution (principal eigenvector) of the row-normalized adjacency matrix of F starting at the localization vector u=(0, . . . , 1, . . . , 0) where a 1 is placed at the object node 205 in the example discussed above.

Now let the fluid mass be placed at object i in Γ, then define the order k diffusion similarity of i to j, denoted by g^{(k)}(i, j), as the mass of the fluid starting at i ending up at j after k rounds in Γ, or 2k rounds in B. It is noted that similar objects, that is those with similar features and strengths, have stronger connection in the bipartite graph B than dissimilar objects and consequently the k-round transition fraction between them in Γ will be higher. This family of similarity measures can thus be seen as a truncated and localized version of the principal eigenvector computation on Γ. Unlike this computation, the finite step transition fraction between a pair of nodes (i, j) on Γ can be used as a measure of similarity between i and j, which the principal eigenvector does not provide.

The graph diffusion similarity g^{(k)}(i, j) is not necessarily symmetric, therefore a reversed graph diffusion similarity can be defined as r^{(k)}(i, j):=g^{(k)}(j, i), which quantifies the k-step similarity of j to i. To balance the importance of each feature, each feature vector's row-sum to may be normalized to 1 and then the graph diffusion similarity may be computed. The corresponding similarity, denoted by n^{(k)}(i, j), is referred to herein as the normalized graph diffusion similarity. The normalized graph diffusion similarity can be shown to be symmetric: n^{(k)}(i, j)=n^{(k)}(j, i), as discussed below. All of the above are measures of similarity each with a corresponding measure of distance: g_{d}^{(k)}(i, j):=1−g^{(k)}(i, j), r_{d}^{(k)}(i, j):=1−r^{(k)}(i, j), and n_{d}^{(k)}(i, j):=1−n^{(k)}(i, j), which are the graph diffusion distance, reversed graph diffusion distance, and normalized graph diffusion distance, respectively.

In some embodiments, the above graph diffusion similarity and distance measures can be computed in matrix form. For the n×m feature matrix W=(wᵢⱼ) where 1≤i≤n and 1≤j≤m, an n×n diagonal matrices P=(pᵢⱼ) and m×m matrices Q=(qᵢⱼ) may be defined as:

$${p}_{ll} = {\sum }_{s = 1}^{m} {w}_{ls} , {q}_{ll} = {\sum }_{s = 1}^{n} {w}_{sl} .$$

In other words, P and Q are the row-sum and column-sum diagonal matrices corresponding to W. It is assumed that pₗₗ and qₗₗ are non-zero, since otherwise the null object can be discarded or the absent feature can be removed. When its dimension is understood, let 1 be the all-one column vector. Define n×n matrix S=(sᵢⱼ) as

S:=P⁻¹WQ⁻¹W^{T}. (1)

Based on the definition of P and Q, it is clear that S is a row-stochastic matrix since:

S1=P⁻¹WQ⁻¹W^{T}1=P⁻¹W1=1.

To compute the mass distribution on B or Γ, the computed matrix S may understood to be the single-step transition matrix on Γ or the two-step transition matrix on B. Let G^{(k)}=(g^{(k)}(i, j)) be the n×n matrix of the pairwise graph diffusion similarity, then it is clear that G⁽¹⁾=S. The higher order diffusion similarity is straightforward to calculate:

G^{(k)}=S^{k}=(P⁻¹WQ⁻¹W^{T})^{k}. (2)

In particular, for g⁽¹⁾(i, j), an explicit formula can be written:

$$\begin{matrix}{g}^{( 1 )} ( i , j ) = {\sum }_{s = 1}^{m} \frac{{w}_{is}}{{w}_{i 1} + … + {w}_{im}} \frac{{w}_{js}}{{w}_{1 s} + … + {w}_{n s}} \\ = \frac{1}{{p}_{ii}} {\sum }_{s = 1}^{m} \frac{{w}_{is} {w}_{js}}{{q}_{ss}} .\end{matrix} \qquad ( 3 )$$

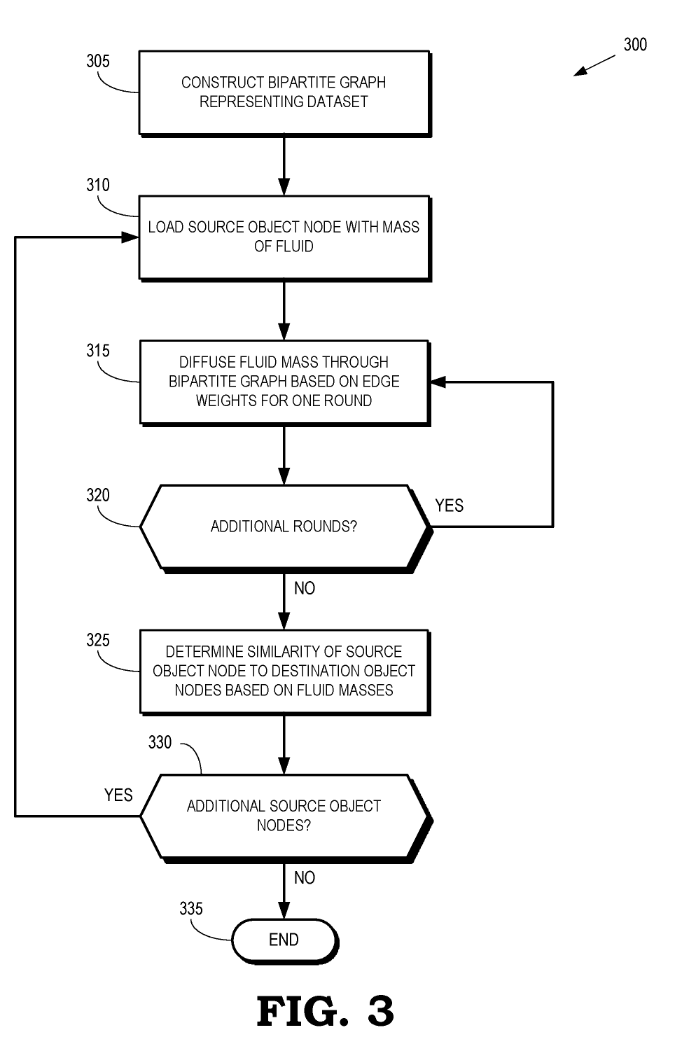

A true “metric” has four key properties: (1) values of the metric are non-negative, (2) the metric is symmetric, (3) the metric satisfies the triangle inequality, and (4) the distance between a point and itself in the metric is zero, e.g., two objects having the same values of the features that define the objects are identical. A “meta-metric” satisfies properties (1), (2), and (3). For example, a function d(⋅,⋅) is a metametric if d is non-negative, symmetric, d(x, y)=0 to imply x=y but not necessarily vice versa, and d satisfies the triangle inequality d(x, y)+d(y, z)≥d(x, z). A “quasi-meta-metric” is a meta-metric that is not necessarily symmetric. A quasi-meta-metric is able to capture key asymmetric relations in object feature datasets and provide a good neighborhood structure. The following theorems regarding meta-metrics and quasi-meta-metrics are proven below for the interested reader and for completeness. The graph diffusion measure disclosed in the flow diagraph of FIG. 3 has the properties of a meta-metric and a quasi-meta-metric.

### Theorem 4.1.

A normalized graph diffusion distance of order k, namely n_{d}^{(k)}(⋅,⋅), is a metametric. When applied to distributions or categorical data, the forward, reversed, and normalized graph diffusion distances become identical, and are all metametrics as well.

### Theorem 4.2.

Let P be the row-sum diagonal matrix for W. If min pᵢᵢ/max pᵢᵢ>⅔, then both the forward graph diffusion distance g_{d}⁽¹⁾(⋅,⋅) and the reversed graph diffusion distance r_{d}⁽¹⁾(⋅,⋅) are quasi-metametrics.

In some embodiments, the graph diffusion similarity measure (which is also referred to herein as a graph diffusion distance) may be generated on the basis of a bipartite graph, as discussed herein, and satisfy a set of basic properties. It is clear that

0≤g_{d}^{(k)}(i,j)=1−g^{(k)}(i,j)≤1

since g^{(k)}(i, j) is a (transition) fraction or transferred mass.

### Proposition 4.3.

If g_{d}^{(k)}(i, j)=0, then i=j and object i is isolated from the rest of the objects. If g_{d}^{(k)}(i, j)=1 for any k, then object j can not be reached by object i in Γ.

### Proof.

If g_{d}^{(k)}(i, j)=0, then g^{(k)}(i, j)=1, then all the fraction measure at i is transferred to j after k rounds. If i≠j, then there should be a feature s such that wᵢₛ>0 in order for the mass fraction starting at i to propagate to j via a path. However, wᵢₛ>0 means that i is also connected to itself and thus there will always be a positive fraction at i, which implies g_{d}^{(k)}(i, j)>0. Thus, by contradiction, i=j and for any s such that wᵢₛ>0, wₗₛ=0 for l≠i, hence i is isolated. On the other hand, if g_{d}^{(k)}(i, j)=1 for all k, then there is zero fraction transferred from i to j in any steps, therefore there is no path from i to j in Γ.

It can be seen that g_{d}^{(k)}(i, i) may not be 0, due to dispersion of mass to other nodes through common features. As for symmetry in the graph diffusion similarity, it is can be seen from equation (3) that g_{d}^{(l)}(i, j) is not symmetric in general. However, one can set forth:

### Proposition 4.4.

A sufficient condition for G⁽¹⁾ to be symmetric is that pᵢᵢ are the same for all i. If the bipartite graph is connected, then the condition that all the pᵢᵢ are the same is also necessary for G⁽¹⁾ to be symmetric.

### Proof.

The first part is straightforward by equation (3). For the second part of the statement, it is noted that for any pair (i, j), there should be a connected path i, k, . . . , j, and i being connected to k means wᵢ₁wₖ₁+ . . . +wᵢₘwₖₘ>0 and thus pᵢᵢ=pₖₖ according to equation (3). The same principle holds for any consecutive objects in the path between i and j, which leads to the conclusion that pᵢᵢ=pⱼⱼ.

The last requirement for the graph diffusion distance to qualify as a meta-metric or quasi-meta-metric is the triangle inequality, as discussed below.

The following discussion of the triangle inequality for embodiments of the graph diffusion similarity measures discussed herein assumes that pᵢᵢ is a constant for all i, which could be achieved via scaling. This condition ensures the resulting graph diffusion distance is a metametric. It is clear that the normalized graph diffusion distance satisfies this condition, since it normalizes the feature weights before calculating similarity. Further, for distributional data and categorical data this condition always holds since for distributions pᵢᵢ=1, and for categorical data, pᵢᵢ equals the number of categories. Therefore, the forward, reversed, and normalized variants of the graph diffusion distance are identical when applied to distributions or categorical data. The following analysis uses n_{d}^{(k)}(⋅,⋅) for concreteness, and the proof for distributions and categorical data directly follows. First it is noted that symmetry follows directly from Proposition 4.1. Based on the above discussion, what is left to show is the triangle inequality. Notice that now equation (3) simplifies to:

$${n}_{d}^{( 1 )} ( i , j ) = 1 - {\sum }_{k = 1}^{m} \frac{{w}_{ik} {w}_{jk}}{{q}_{kk}} .$$

Without loss of generality, it can be proved that n_{d}⁽¹⁾(1,2)+n_{d}⁽¹⁾(2,3)≥n_{d}⁽¹⁾(1,3), which is expanded as:

$${\sum }_{k = 1}^{m} \frac{( {w}_{1 k} + {w}_{3 k} ) {w}_{2 k} - {w}_{1 k} {w}_{3 k}}{{q}_{kk}} \leq 1. \qquad ( 4 )$$

Notice that w₁ₖw₃ₖ≥0 and qₖₖ≥w₁ₖ+w₂ₖ+w₃ₖ, then it is sufficient to prove that:

$${\sum }_{k = 1}^{m} \frac{( {w}_{1 k} + {w}_{3 k} ) {w}_{2 k}}{{w}_{1 k} + {w}_{2 k} + {w}_{3 k}} \leq 1.$$

It is easy to check

$$\frac{xy}{x + y} \leq \frac{1}{9} x + \frac{4}{9} y$$

holds for any x and y given x+y>0, since it is equivalent to (x−2y)²≥0. By letting x=w₁ₖ+w₃ₖ and y=w₂ₖ, one arrives at:

$${\sum }_{k = 1}^{m} \frac{( {w}_{1 k} + {w}_{3 k} ) {w}_{2 k}}{{w}_{1 k} + {w}_{2 k} + {w}_{3 k}} \leq \frac{1}{9} {\sum }_{k = 1}^{m} ( {w}_{1 k} + {w}_{3 k} ) + \frac{4}{9} {\sum }_{k = 1}^{m} {w}_{2 k} = \frac{2}{3} < 1 ,$$

which completes the proof.

The coefficient ⅔ in the above equation is tight in the sense that there exists a construction of W such that all the above inequalities become equality. The construction is as follows:
Let w₁₁=1, w₁₂=0, w₂₁=w₂₂=½, w₃₁=0, w₃₂=1.
Let w₁ₖ=w₂ₖ=w₃ₖ=0 for k≥3.
For all r≥4, let wᵣ₁=wᵣ₂=0.
Set wᵣₖ to any non-negative value such that wᵣ₃+ . . . +wᵣₘ=1.
   It is clear that W under the above construction is row-stochastic. Besides, g_{d}⁽¹⁾(1,2)=g_{d}⁽¹⁾(2,3)=⅓ and g_{d}⁽¹⁾(1,3)=0, and hence g_{d}⁽¹⁾(1,2)+g_{d}⁽¹⁾(2,3)−g_{d}⁽¹⁾(1,3)=⅔. The following has therefore been proved: For any row-stochastic matrix W and its column-sum diagonal matrix Q, define matrix D=(dᵢⱼ) as D:=11^{T}−WQ⁻¹W^{T}. Then D is a symmetric matrix, and the triangular inequality dᵢⱼ+dⱼₖdᵢₖ holds for any 1≤i, j, k≤n.

Next the triangle inequality is considered for general order r. It is proved that:

### Proposition 4.6.

For any row-stochastic matrix W with its column-sum diagonal matrix Q, define matrix D^{(r)}:=(dᵢⱼ^{(r)}) as D^{(r)}:=11^{T}−(WQ⁻¹W^{T})^{r}. Then the triangular inequality dᵢⱼ^{(r)}+dⱼₖ^{(r)}≥dᵢₖ^{(r)} holds for any 1≤i, j, k≤n and any positive integer r.

### Proof.

The statement for r=1 is proved in Proposition 4.2. We will consider the case r=2u (an even number) and the case r=2u+1 (an odd number) separately. For the case r=2u, denote ^{□}W=(WQ⁻¹W^{T})^{u}, then ^{□}W is symmetric. Since both W and Q⁻¹W^{T} are row-stochastic, ^{□}W is actually doubly-stochastic, and D^{(r)}=11^{T}−^{□}W ^{□}W^{T}. Since W is row-stochastic, then so is ^{□}W=WQ⁻¹W^{T}, thus the corresponding column-sum diagonal matrix ^{□}Q for ^{□}W becomes an identity matrix. By regarding ^{□}W as a new feature matrix W in Proposition 4.2, the triangular inequality follows immediately.

For the case r=2u+1, let W̅=^{□}W W, then

D^{(r)}=11^{T}−^{□}W WQ⁻¹W^{T □}W^{T}=11^{T}−W̅Q⁻¹W̅^{T}. (5)

Recalling Proposition 4.2, one can show that W̅ is a row-stochastic matrix and Q is its column-sum matrix. Since both ^{□}W and W are row-stochastic matrices, so is W̅=^{□}W W. For its column-sum, since ^{□}W is doubly-stochastic, W̅^{T}1=W^{T □}W^{T}1=W^{T}1, thus W̅ and W share the same column-sum matrix Q, which completes the proof.

Theorem 4.1 follows directly from Proposition 4.3, Proposition 4.4, and Proposition 4.5.

For the forward graph diffusion distance g_{d}^{(k)}(⋅,⋅) and its reversed version r_{d}^{(k)}(⋅,⋅), symmetry is no longer guaranteed. Besides, triangle inequality need not hold in general. One can find sufficient conditions for these distances to be at least quasi-metametrics. A counter-example to the triangle inequality is provided by these three objects and two features: W=[1,0;2,6;0,12]. It is straightforward to check that g_{d}⁽¹⁾(1,2)+g_{d}⁽¹⁾(2,3)−g_{d}⁽¹⁾(1,3)=⅓+½−1<0, and also r_{d}⁽¹⁾(3,2)+r_{d}⁽¹⁾(2,1)−g_{d}⁽¹⁾(3,1)=⅓+½−1<0. The reason for failure of the triangle inequality is that different features have distinct total sums of features Theorem 4.2 can now be proven.

### Proof.

Based on the discussion in Section 4.1, one needs to prove the triangle inequality. Again, one needs to prove g_{d}⁽¹⁾(1,2)+g_{d}⁽¹⁾(2,3)≥g_{d}⁽¹⁾(1,3) without loss of generality. Following the proof in Proposition 4.5, it suffices to show that

$${\sum }_{k = 1}^{m} \frac{( {w}_{1 k} / {p}_{11} + {w}_{3 k} / {p}_{22} ) {w}_{2 k} - {w}_{1 k} {w}_{3 k} / {p}_{11}}{{q}_{kk}} \leq 1. \qquad ( 6 )$$

Following the same argument in the proof of Proposition 4.2, one has

$${\sum }_{k = 1}^{m} \frac{( {w}_{1 k} / {p}_{11} + {w}_{3 k} / {p}_{22} ) {w}_{2 k} - {w}_{1 k} {w}_{3 k} / {p}_{11}}{{q}_{kk}} \leq {\sum }_{k = 1}^{m} \frac{( {w}_{1 k} / {p}_{11} + {w}_{3 k} / {p}_{22} ) {w}_{2 k}}{{w}_{1 k} + {w}_{2 k} + {w}_{3 k}} \leq \frac{2}{3} \frac{max {p}_{ii}}{min {p}_{ii}} = 1 ,$$

which completes the proof of Theorem 4.2.

Theorem 4.2 shows that, if the row-sums of the features are comparable, then the order 1 forward graph diffusion distance and its reversed version are quasi-metametrics. However, since the similarity vector g^{(k)}(i,⋅) eventually converges to the equilibrium vector of the graph Γ, the triangle inequality cannot hold for large k if the equilibrium vector itself does not follow the triangle inequality. On the other hand, the similarity vector r^{(k)}(i,⋅) converges to a vector of a constant, thus triangle inequality holds.

The computational cost of the graph diffusion distance computed in accordance with the disclsosure can also be estimated. For computing a single pair similarity, equation (3) shows that the cost is O(mn), which is less than ideal. For example, the Euclidean distance or cosine similarity only requires O(m) calculations. However, graph diffusion similarity for one pair of objects is not as important as the similarity between a set of objects and a fixed object. Thus, for similarity searches and related tasks relative to an object i, a computation of g⁽¹⁾(i, j) for all j followed by ranking, may be needed. From the matrix form in equation (1), it is clear that the computational cost for this task in accordance with the embodiments disclosed herein is still O(mn), which scales linearly in the number of objects and the number of features. In contrast, it can also be seen from equation (1) that for other conventional similarity altorithms, the computation of the graph diffusion similarity for all the pairs of objects requires O(mn²) calculations, which is the same as other traditional similarities. In the systems and methods described herein, the reversed and normalized variants only involve matrix transpose and normalization operations, thus the computational cost is in the same order in contrast to traditional computational approaches. Since the calculation of the graph diffusion distance can be written in the matrix form of equation (1), parallel computing is also straightforward to use if and when needed.

FIG. 3 is a flow diagram of a method 300 of utilizing a graph diffusion similarity measure to determine similarity values for object nodes derived from a dataset according to some embodiments. The method 300 is implemented in some embodiments of the processor 105 shown in FIG. 1.

At block 305, the processor constructs a bipartite graph representing a dataset. For example, the processor can map points in the dataset to object nodes and non-negative elements of a feature vector to feature nodes. The object nodes and the feature nodes are linked by edges that are associated with weights that are determined by the values of the non-negative elements of the feature vectors for the points associated with the object nodes, as discussed herein.

At block 310, the processor loads a source object node with a predetermined mass of fluid. At block 315, the processor distributes the mass from the source object node and through the bipartite graph based on the edge weights, e.g., by allowing the fluid mass to diffuse through the bipartite graph. The fluid is distributed for one round, which includes diffusion of the mass from the object nodes to the feature nodes and a diffusion of the mass from the feature nodes back to the object nodes. At decision block 320, the processor determines whether there are additional rounds to be completed. The number of rounds can be predetermined and can have a value equal to one or more rounds. If there are additional rounds to be completed, the method 300 flows back to block 315. If all of the predetermined number of rounds have been completed, the method 300 flows to block 325.

At block 325, the processor determines a similarity of the source object node to the other (destination) object nodes in the bipartite graph based on the fluid masses at the destination nodes after the mass distribution process. The similarity is represented by a similarity value. For example, a similarity value that represents a degree of similarity between the source object node and a destination object node can be set equal to a mass of fluid at the destination object node.

At decision block 330, the processor determines whether there are additional source object nodes to be evaluated. If so, the method 300 flows back to block 310. If not, the method 300 flows to block 335 and ends.

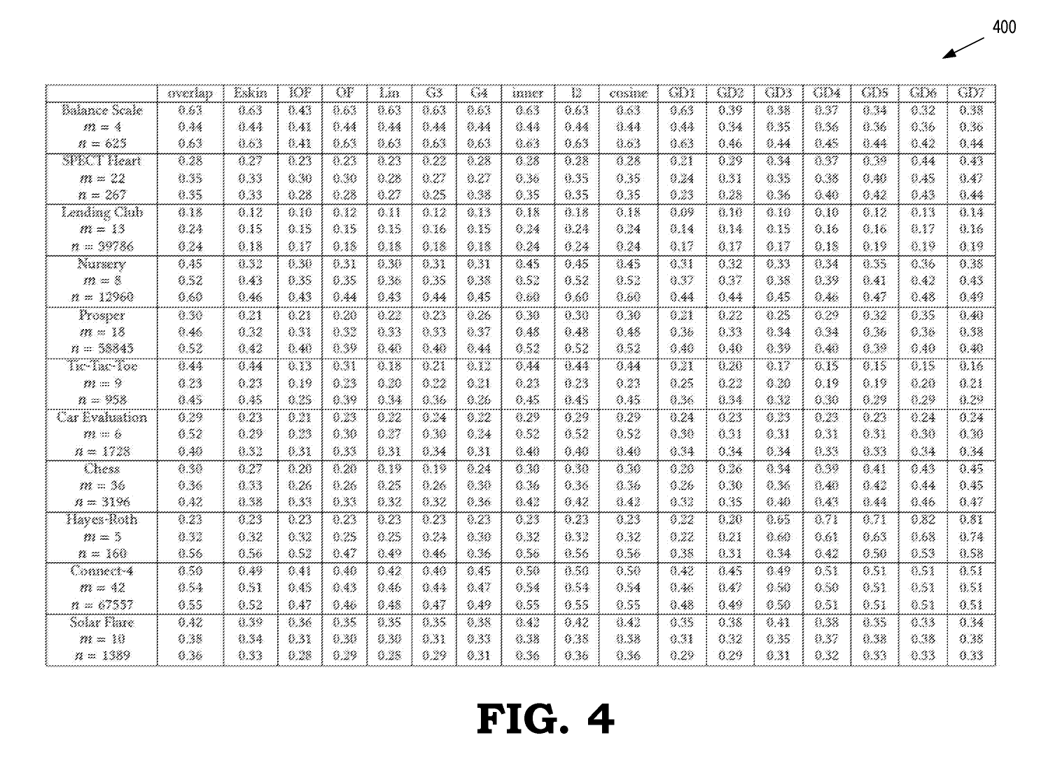

FIG. 4 is a table 400 that compares similarity values produced by applying different similarity measures, including graph diffusion similarity measures, to a selection of different datasets. The rows of the table 400 correspond to the different datasets and the columns corresponds to the different similarity measure algorithms. Entries in the table indicate the error value for the similarity measure algorithm. For each similarity measure algorithm, let x be any chosen data point and y the corresponding label that is determined based on the similarity values calculated using the corresponding similarity measure. To test the performance of a similarity measure S, the data points are ranked with respect to their similarities to x. Then for any 0<f≤1, the proportion of data points that hold different labels compared to y in the nf-nearest neighbors of x is calculated, which yields the error value e^{S}(x, f) of data point x at f. The error curve is defined as the averaged error for all the data points:

$${E}^{S} ( f ) := \frac{1}{n} {\sum }_{x} {e}^{S} ( x , f ) . \qquad ( 7 )$$

Notice that E^{S}(1) does not depend on the similarity measure that is used to calculate the similarity values that determine the labels that are used to calculate the error values. It is determined by the number of data points in each class. For example, if the data set contains two classes of equal number of data points, then E^{S}(1)=0.5. For convenience, define E^{S}(0)=0. The error curve E^{S}(f) is expected to grow when f becomes larger, though this trend is not guaranteed. In the following experiments, this curve fluctuates in some cases, but most of the time it increases monotonically.

Table 400 compares the performance of ten existing similarity measures and the graph diffusion similarity measures of order 1 to 7, denoted by GD1 to GD7. The existing similarity measures include overlap, Eskin, IOF, OF, Lin, Goodall3, Goodall4, inner product, Euclidean, and cosine. Reversed graph diffusion is used during the experiments. Recall that, when applied to categorical features, all graph diffusion similarities coincide. Among the tested data sets, the results of 11 are shown in Table 400. In table 400, nine of the shown data sets are from the UCI Machine Learning Repository. The LC and PR are loan level data sets from the two largest P2P sites, Prosper and Lending Club. For each dataset, the three rows include the values of E^{S}(0.01), E^{S}(0.02), and E^{S}(0.05), respectively, which correspond to the averaged errors at 1%, 2%, and 5% of nearest neighbor sets.

The results in Table 400 demonstrate that no single similarity measure dominates all others. The order 1 forward graph diffusion similarity g⁽¹⁾(⋅,⋅) is among the best, while IOF, Lin, and Goodall3 also perform well on certain data sets. In addition, it can be observed that g⁽¹⁾(⋅,⋅) usually performs the best compared to its higher order versions.

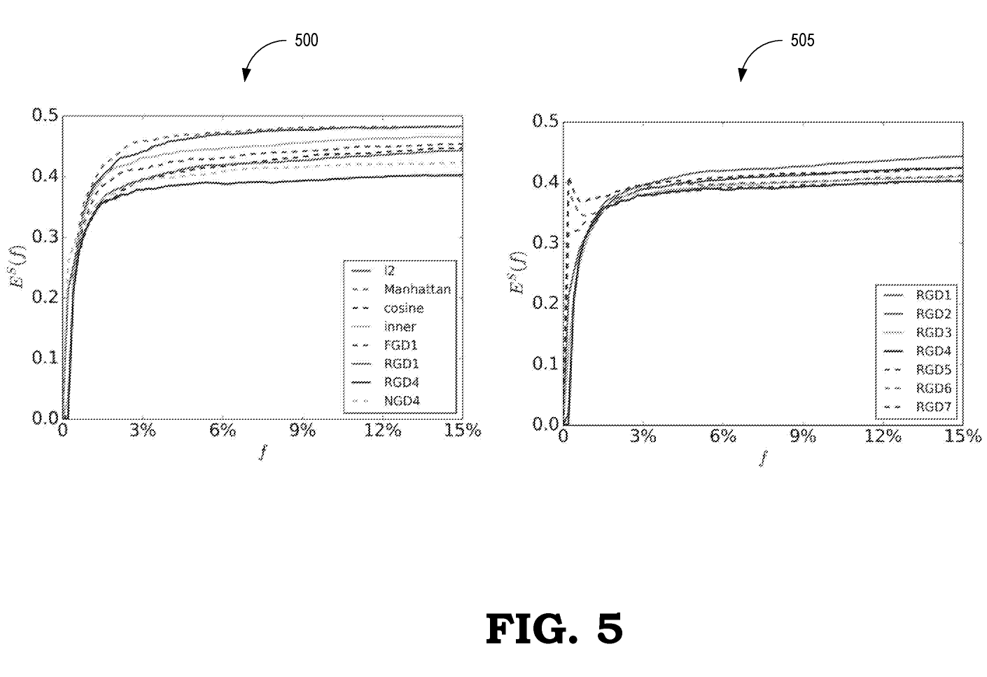

FIG. 5 shows plots 500, 505 of error curves for a term frequency-inverse document frequency (tf-idf) representation of an IMDb movie review dataset according to some embodiments. The vertical axes indicate the averaged error and the horizontal axes indicate a fraction f of the nearest neighbors that are included in the calculation of the error curve. For an integer s and a data point, the proportion of data points holding the same label out of its s-nearest neighbors is calculated under the given similarity measure and then the averaged error is calculated over all the data points. The performance of each similarity measure is quantified by the error curve E^{S}(f) staring at the origin and rising when f increases.

The IMDb dataset is an example of an unstructured data set that includes 50,000 movie reviews in text form. The length of the review varies from very short to more than 2,000 words. Each movie review is associated with a binary sentiment polarity label. There are 25,000 positive reviews and 25,000 negative reviews. A good similarity measure should yield a higher similarity value for reviews holding the same label and lower similarity value for reviews with different labels. Under an ideal similarity measure, similarity values should indicate that the distance between the same type of reviews is almost negligible, yet the similarity values for reviews holding different opinions should be far away from each other. The labels of each review in the IMDb dataset are known, which makes the test straightforward to carry out.

The tf-idf representation is derived by associating the importance of a word in a review with the word's frequency in that review multiplied by the word's inverse document frequency in the entire corpus. Let t_{f} be the frequency of the word in the review, d_{f} be the number of reviews that contain this word, and recall that n is the number of reviews. The tf-idf value is defined as t_{f} log(n/d_{f}).

The plot 500 illustrates the error curves of the forward graph diffusion similarity measure, its reversed and normalized variants, and several traditionally used similarity measures. The plot 500 demonstrates that the traditional measures including Euclidean, Manhattan, inner product, and cosine, are considerably outperformed by the reversed and the normalized graph diffusion similarity measures. The family of graph diffusion similarity measures also perform differently. The plot 505 demonstrates that, for the reversed graph diffusion similarity measures of order from 1 to 7, the performances improves and later decreases as the order increases, and the order 4 and order 5 curves are the best among the seven.

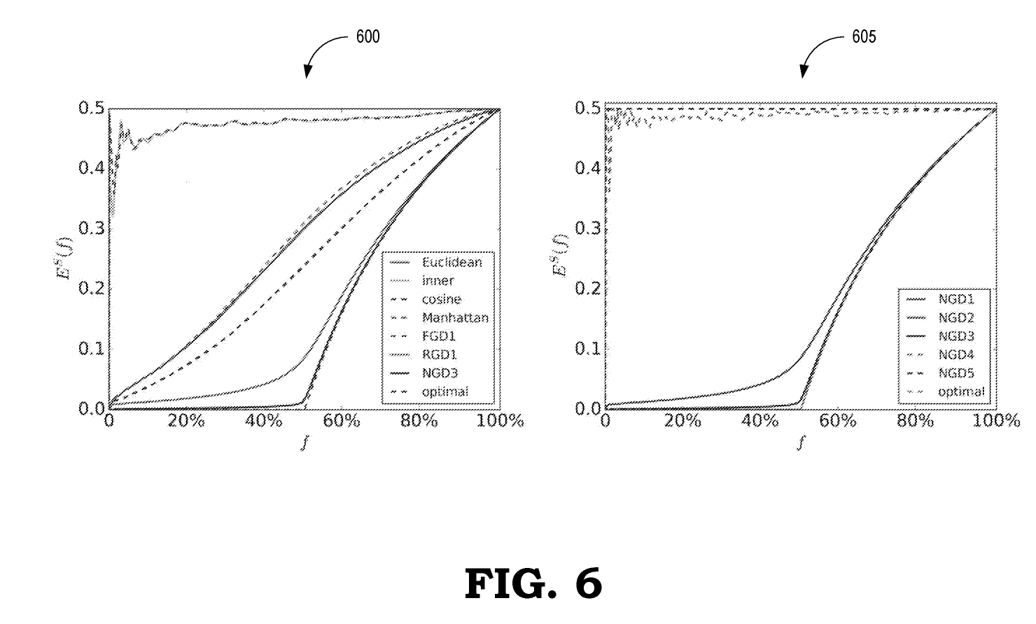

FIG. 6 shows plots 600, 605 of error curves for a compact embedded representation of the IMDb movie review dataset according to some embodiments. The vertical axes indicate the averaged error and the horizontal axes indicate a fraction f of the nearest neighbors that are included in the calculation of the error curve. Deep learning is used to embed the reviews from the IMDb database into a vector space, e.g., using a deep convolutional neural network (CNN). The input layer of the CNN converts any incoming paragraph into a vector of undetermined length, then different sizes of convolutional windows further transform the vector into vectors of values. After that, a max pooling layer of the CNN eliminates the varying length and thus the number of nodes is the same as the number of convolution windows. After the training session, the part of the CNN from the input layer to the last hidden layer itself becomes a function that maps any paragraph of texts into a fixed length of vector.

The vectors used to produce the plots 600, 605 are from a CNN with 128 convolution kernels and thus the feature vector consists of 128 dimensions. Similar results are observed for different sizes of CNN as long as the number is not too small to lose track of the original information in the sentences. The optimal error curve is shown in plots 600, 605 for reference. The optimal error curve corresponds to the optimal similarity measure under which each review's neighbors always have the same opinion label and the reviews holding different labels are far away from each other. Therefore, the first half of the optimal error curve is 0 and then it gradually increases to 0.5. The plot 600 illustrates that the reversed and normalized graph diffusion similarity measures outperform others in a clear way. The plot 605 illustrates that the order 2 normalized graph diffusion similarity almost coincides with the optimal curve.

A comparison of FIG. 2 and FIG. 6 demonstrates that when the order of the distribution on the bipartite graph increases, the performance increases at first (first phase) up to a critical order but then decreases later to become completely random (second phase). This second phase is natural because the graph diffusion similarity measure d^{(k)}(i,⋅) converges to the equilibrium vector of the graph, and the reversed and normalized versions converge to vector of a constant, all of which are doomed to be poor. As for the first phase and its critical order, for the compact representation in FIG. 6, the best performance is achieved at order 2, whereas for the sparse representation of tf-idf in FIG. 5, the optimal order is at 4 or 5. The speed of the information propagation in the graph is highly related to the sparsity of the feature matrix W. When W or the bipartite graph is too sparse, the similarity between a pair of objects is not adequately quantified if the initial mass is not well diffused throughout the bipartite graph. Thus, higher order distributions are required to achieve good performance for sparse data.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method for implementation in a computer that includes at least one processor configured to execute instructions representing the method, the method comprising:
mapping a dataset to a plurality of objects, wherein the objects are represented by corresponding values of a plurality of non-negative elements;
constructing a bipartite graph including a plurality of first nodes associated with the plurality of objects and a plurality of second nodes associated with the plurality of non-negative elements, wherein the first nodes are linked to the second nodes by edges having weights equal to values of the non-negative elements that represent the corresponding first node; and
determining similarity values that indicate degrees of similarity between the plurality of objects based on a diffusion of a fluid mass through the bipartite graph according to the weights of the edges.

2. The method of claim 1, wherein mapping the dataset to the plurality of objects comprises mapping at least one of a categorical dataset, continuous dataset, or an unstructured dataset to the plurality of objects.

3. The method of claim 1, wherein the weight associated with an edge indicates a fraction of the fluid mass that transitions between a first node and a second node connected by the edge during the diffusion.

4. The method of claim 3, wherein a first weight associated with an edge indicates a first fraction of the fluid mass that transitions from the first node to the second node and a second weight associated with the edge indicates a second fraction of the fluid mass that transitions from the second node to the first node, wherein the first weight is different than the second weight, and wherein the first fraction is different than the second fraction.

5. The method of claim 3, further comprising:
normalizing the weights associated with the edges so that the sum of weights of edges associated with each first node is equal to a predetermined value.

6. The method of claim 1, wherein determining the similarity values based on the diffusion comprises:
loading one of the first nodes with a portion of the fluid mass;
distributing the portion from the one of the first nodes to a subset of the second nodes with fractions determined by weights of the edges connecting the one of the first nodes to the subset of the second nodes; and
distributing the portion from the subset of the second nodes to a subset of the first nodes with fractions determined by weights of the edges connecting the subset of the second nodes to the subset of the first nodes to complete a round of the diffusion.

7. The method of claim 6, wherein determining the similarity values comprises iteratively performing a predetermined number of rounds of the diffusion.

8. The method of claim 7, wherein determining the similarity values comprises setting similarity values that indicate similarities between the one of the first nodes and the plurality of second nodes equal to fluid masses at the plurality of second nodes following the diffusion.

9. The method of claim 8, wherein higher fluid masses at the plurality of second nodes indicate higher degrees of similarity with the one of the first nodes.

10. An apparatus comprising:
a memory configured to store a dataset; and
a processor configured to:
map the dataset to a plurality of objects, wherein the objects are represented by corresponding values of a plurality of non-negative elements;
construct a bipartite graph including a plurality of first nodes associated with the plurality of objects and a plurality of second nodes associated with the plurality of non-negative elements, wherein the first nodes are linked to the second nodes by edges having weights equal to values of the non-negative elements that represent the corresponding first node; and
determine similarity values that indicate degrees of similarity between the plurality of objects based on diffusion of a fluid mass through the bipartite graph according to the weights of the edges.

11. The apparatus of claim 10, wherein the dataset comprises at least one of a categorical dataset, continuous dataset, or an unstructured dataset to the plurality of objects.

12. The apparatus of claim 10, wherein the weight associated with an edge indicates a fraction of a fluid mass that transitions between a first node and a second node connected by the edge during the diffusion.

13. The apparatus of claim 12, wherein a first weight associated with an edge indicates a first fraction of a fluid mass that transitions from the first node to the second node and a second weight associated with the edge indicates a second fraction of a fluid mass that transitions from the second node to the first node, wherein the first weight is different than the second weight, and wherein the first fraction is different than the second fraction.

14. The apparatus of claim 12, wherein the processor is configured to normalize the weights associated with the edges so that the sum of weights of edges associated with each first node is equal to a predetermined value.

15. The apparatus of claim 10, wherein the processor is configured to determine the similarity values by:
loading one of the first nodes with a portion of the fluid mass;
distributing the portion from the one of the first nodes to a subset of the second nodes according to fractions determined by weights of the edges connecting the one of the first nodes to the subset of the second nodes; and
distributing the portion from the subset of the second nodes to a subset of the first nodes with according to fractions determined by weights of the edges connecting the subset of the second nodes to the subset of the first nodes to complete a round of the diffusion.

16. The apparatus of claim 15, wherein the processor is configured to iteratively perform a predetermined number of rounds of the diffusion.

17. The apparatus of claim 16, wherein the processor is configured to set similarity values that indicate similarities between the one of the first nodes and the plurality of second nodes equal to fluid masses at the plurality of second nodes following the diffusion.

18. The apparatus of claim 17, wherein higher fluid masses at the plurality of second nodes indicate higher degrees of similarity with the one of the first nodes.

19. A non-transitory computer readable medium embodying a set of executable instructions, the set of executable instructions to manipulate at least one processor to:
map a dataset to a plurality of objects, wherein the objects are represented by corresponding values of a plurality of non-negative elements;
construct a bipartite graph including a plurality of first nodes associated with the plurality of objects and a plurality of second nodes associated with the plurality of non-negative elements, wherein the first nodes are linked to the second nodes by edges having weights equal to values of the non-negative elements that represent the corresponding first node; and
determine similarity values that indicate degrees of similarity between the plurality of objects based on a diffusion of a fluid mass through the bipartite graph according to the weights of the edges.

20. The non-transitory computer readable medium of claim 19, wherein the set of executable instructions is to manipulate the at least one processor to:
load one of the first nodes with a portion of the fluid mass;
distributing the portion from the one of the first nodes to a subset of the second nodes with fraction determined by weights of the edges connecting the one of the first nodes to the subset of the second nodes; and
distributing the portion from the subset of the second nodes to a subset of the first nodes with fractions determined by weights of the edges connecting the subset of the second nodes to the subset of the first nodes to complete a round of the diffusion.
